(19) United States
(12) Patent Application Publication
(10) Pub. No.: US 2011/0066960 A1
(43) Pub. Date: Mar. 17, 2011

(54) Program download system, program download method, image forming apparatus, program delivery server, and download program

(75) Inventor: Tomohiro Suzuki, Tokyo (JP)

(73) Assignee: Ricoh Company, Limited

(21) Appl. No.: 12/923,239

(22) Filed: Sep. 10, 2010

(30) Foreign Application Priority Data
Sep. 14, 2009 (JP) 2009-212473

(51) Int. Cl. G06F 3/048; G06F 15/16; G06F 9/44

(52) U.S. Cl. 715/764; 709/219; 717/173

(57) ABSTRACT

When a user requests a download of a program, an MFP creates device information that includes at least information on an operation screen that corresponds to an application function that is being performed at that time and sends the device information to a program delivery server. The program delivery server creates a download list by extracting, from among all the deliverable programs in accordance with the device information received from the MFP, only programs that correspond to an operation status of the image forming apparatus and then sends the download list to the MFP. The MFP displays the download list created by the program delivery server.

### PRIORITY CLAIM

The present application claims priority to and incorporates by reference the entire contents of Japanese Patent Application No. 2009-212473 filed in Japan on Sep. 14, 2009.

### BACKGROUND OF THE INVENTION

1. Field of the Invention

The present invention relates to a program download system, a program download method, an image forming apparatus, a program delivery server and a download program in which, between the image forming apparatus serving as a client terminal and the program delivery server, by communicating using an information communication network, programs delivered from the program delivery server are downloaded to the image forming apparatus.

2. Description of the Related Art

With a conventional technology, by using information communication such as the Internet, and by communicating between client terminals and servers, programs delivered from the servers are commonly downloaded, via the information communication network, to the client terminals.

In recent years, image forming apparatuses, such as copiers, printers, scanners, facsimiles, and MFPs that have these functions, usually have a communication function that is performed via information communication networks. With image forming apparatuses having such a communication function, it is possible to download, from program delivery servers via the information communication networks, programs that are used to upgrade the versions of installed applications or that are used to add applications.

A known technology in which an image forming apparatus downloads programs delivered from a program delivery server via an information communication network is disclosed in, for example, Japanese Patent No. 3602036. With the technology disclosed in Japanese Patent No. 3602036, the program delivery server displays, on an operation displaying unit of the image forming apparatus, a download list that is created by extracting, from among all of the programs that can be delivered, only programs that run in the operating environment of the image forming apparatus and then downloads a program that is in the download list and that is selected by a user, thereby reducing the inconvenience of the operation for the user.

However, with the technology disclosed in Japanese Patent No. 3602036, if programs are operable in the operating environment of the image forming apparatus, even though the programs are not related to an application that is currently executed by the image forming apparatus, i.e., the programs are not related to a service that is currently used by a user and are less likely to be selected as target download programs, the programs are included in the download list and are displayed. Accordingly, because the number of programs in the download list tends to increase, users need to search, from among many displayed programs, for a desired program and select it as a target download program, which causes an operation for selecting a program that is to be downloaded to be inconvenient for users.

### SUMMARY OF THE INVENTION

It is an object of the present invention to at least partially solve the problems in the conventional technology.

One aspect of the invention relates a program download system. The system includes a program delivery server that delivers a program via an information communication network; and an image forming apparatus that is connected to the information communication network and downloads the program that is delivered from the program delivery server.

The image forming apparatus includes an operation window displaying unit that displays an operation screen that corresponds to an application function that is currently being performed by the image forming apparatus; an input unit that receives an operation input performed by a user; a download request determining unit that determines whether an operation input in which a user requests a program download has been performed; a device information creating unit that creates device information that includes at least information on the operation screen that is displayed on the operation window displaying unit when the user requests the program download; a device information sending unit that sends, to the program delivery server, the device information together with the download list send request; a download list receiving unit that receives, as a response to the download list send request, a download list that is sent from the program delivery server; a download list displaying unit that displays the download list; a download start request sending unit that sends, to the program delivery server, a download start request that specifies a program that is selected by the user from the download list; and a program receiving unit that receives, as a response to the download start request, the program that is sent from the program delivery server.

The program delivery server includes a device information receiving unit that receives the device information that is sent, together with the download list send request, from the image forming apparatus; a download list creating unit that extracts, from among all deliverable programs in accordance with the device information, only programs that correspond to an operation status of the image forming apparatus to create the download list; a download list sending unit that sends the download list to the image forming apparatus; a download start request receiving unit that receives the download start request that is sent from the image forming apparatus; and a program sending unit that sends, to the image forming apparatus, the program that is specified by the download start request.

Another aspect of the invention relates to an image forming apparatus that is connected to an information communication network and has a function of downloading a program that is delivered from a program delivery server via the information communication network.

The image forming apparatus includes an operation window displaying unit that displays an operation screen that corresponds to an application function that is currently being performed by the image forming apparatus; an input unit that receives an operation input performed by a user; a download request determining unit that determines whether an operation input in which a user requests a program download has been performed; a device information creating unit that creates device information that includes at least information on the operation screen that is displayed on the operation window displaying unit when the user requests the program download; a device information sending unit that sends, to the program delivery server, the device information together with the download list send request; a download list receiving unit that receives, as a response to the download list send request, a download list that is sent from the program delivery server; a download list displaying unit that displays the download list; a download start request sending unit that sends, to the program delivery server, a download start request that specifies a program that is selected by the user from the download list; and a program receiving unit that receives, as a response to the download start request, the program that is sent from the program delivery server.

Still another aspect of the invention relates to a program delivery server that delivers, to an image forming apparatus that is connected to an information communication network, a program via the information communication network.

The program delivery server includes a device information receiving unit that receives, from the image forming apparatus, device information that includes at least information on an operation screen that is displayed on an operation window displaying unit in the image forming apparatus when a user requests a program download of a program using in the image forming apparatus; a download list creating unit that extracts, from among all deliverable programs in accordance with the device information, only programs that correspond to an operation status of the image forming apparatus to create a download list; a download list sending unit that sends the download list to the image forming apparatus; a download start request receiving unit that receives a download start request that specifies a program that is selected from the download list by a user in the image forming apparatus; and a program sending unit that sends, to the image forming apparatus, the program specified by the download start request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating the configuration of a program download system according to an embodiment of the present invention;

FIG. 2 is a block diagram illustrating the functional configuration of an MFP according to the embodiment;

FIG. 3 is a block diagram illustrating the functional configuration, which is used to execute a process related to the present invention, of an application installation control service performed in the MFP;

FIG. 4 is a schematic diagram illustrating an example of device information that is created by a device information creating unit in the application installation control service;

FIG. 5A is a schematic diagram illustrating an example of user operation history information, which is used to create a relevant setting item of the device information and to indicate information on a job that has been completed just before a user requests a download of a program;

FIG. 5B is a schematic diagram illustrating an example of user operation history information, which is used to create a relevant setting item of the device information and to indicate information on a setting value that is changed from a initial value before the user requests a download of the program;

FIG. 5C is a schematic diagram illustrating an example of user operation history information, which is used to create a relevant setting item of the device information and to indicate information on the number of operations for each setting item that is performed until the user requests a download of the program;

FIG. 6 is a schematic diagram illustrating an example of information on the configuration of the MFP that is used to create the device information;

FIG. 7 is a block diagram illustrating the hardware configuration of the MFP;

FIG. 8 is a block diagram illustrating the functional configuration of a program delivery server according to the embodiment;

FIG. 9 is a schematic diagram illustrating an example of program management information managed by a program management unit in the program delivery server;

FIG. 10 is a flowchart illustrating an example flow of a download list creating process performed by a download list creating unit in the program delivery server;

FIG. 11 is a schematic diagram illustrating an example of a download list created by the download list creating unit in the program delivery server;

FIG. 12A is a sequence diagram illustrating the flow of a process performed from when a user performs an operation input that requests a download of a program until when a download list is displayed on an operation panel;

FIG. 12B is a sequence diagram illustrating the flow of a process performed from when a user performs an operation input that selects, from the download list displayed on the operation panel, a desired program until when the program is installed in the MFP;

FIG. 13A is a schematic diagram illustrating a specific example of a change of a screen displayed on the operation panel in the MFP and illustrating an example of an application window that is displayed on the operation panel before a program is downloaded;

FIG. 13B is a schematic diagram illustrating a specific example of a change of a screen displayed on the operation panel in the MFP and illustrating an example of a download window on the operation panel that is displayed after the user presses a download button on the application window;

FIG. 13C is a schematic diagram illustrating a specific example of a change of a screen displayed on the operation panel in the MFP and illustrating an example of a download in progress window that is displayed, during the download of a program, on the operation panel;

FIG. 13D is a schematic diagram illustrating a specific example of a change of a screen displayed on the operation panel in the MFP and illustrating an example of an installation in progress screen that is displayed, during the installation of a program, on the operation panel is illustrated; and

FIG. 13E is a schematic diagram illustrating a specific example of a change of a screen displayed on the operation panel in the MFP and illustrating an example of an application window that is displayed on the operation panel after the program is installed.

### DETAILED DESCRIPTION OF THE PREFERRED EMBODIMENTS

In the following, a preferred embodiment of a program download system, a program download method, an image forming apparatus, a program delivery server, and a download program according to the present invention will be described in detail with reference to the accompanying drawings.

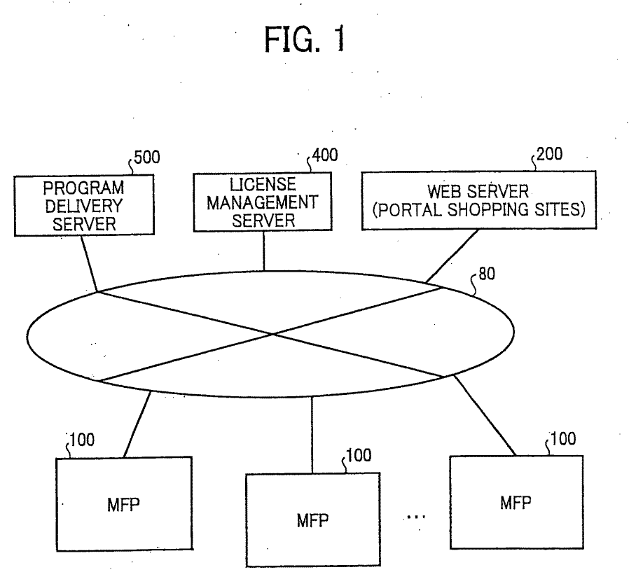

FIG. 1 is a schematic diagram illustrating the configuration of the program download system according to an embodiment of the present invention. As illustrated in FIG. 1, the program download system according to the embodiment includes multiple MFPs (image forming apparatuses) 100, a program delivery server 500, a license management server 400, and a Web server 200, which are connected each other via a network 80, such as the Internet.

The MFPs 100 are client terminals that download programs delivered from the program delivery server 500. In the embodiment, multiple MFPs 100 that are connected to the program delivery server 500 via the network 80 are described as an example; however, a single MFP 100 that is connected to the program delivery server 500 can also be used.

The program delivery server 500 is a server device that holds and manages various programs that are delivered to the MFP 100. The program delivery server 500 supplies, to the MFPs 100 using the network 80 in accordance with requests from the MFPs 100 serving as clients, a specified program.

The license management server 400 is a server device that manages a license (authorization) of a program that is installed in the MFPs 100 and is supplied from the program delivery server 500.

The Web server 200 is a server device that has portal shopping sites for various programs.

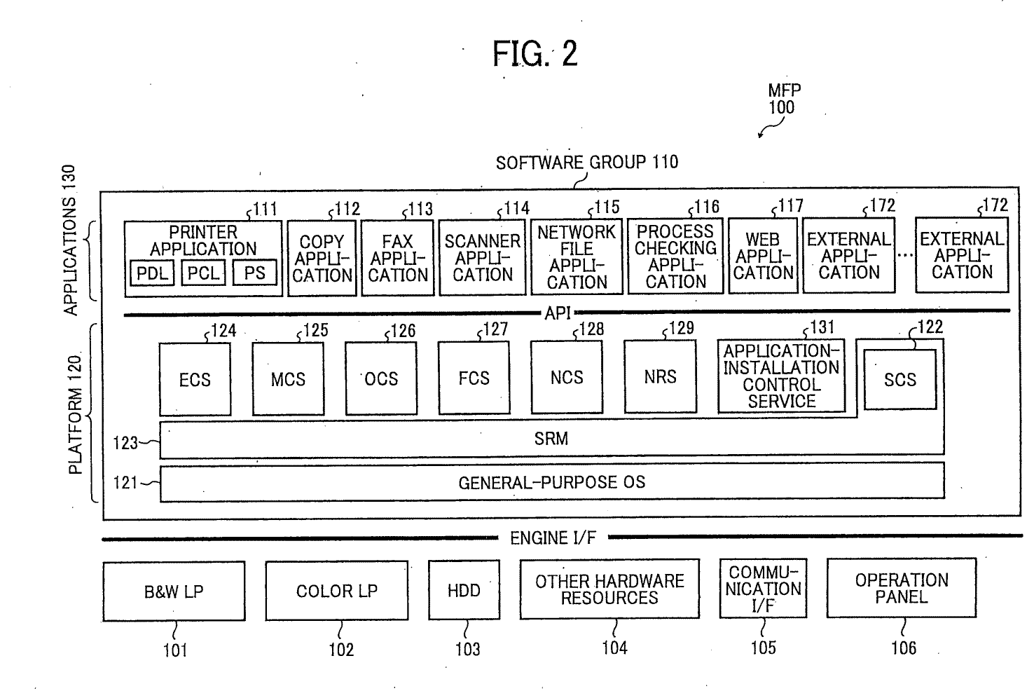

In the following, the MFPs 100 serving as client terminals will be described. FIG. 2 is a block diagram illustrating the functional configuration of the MFP 100.

As illustrated in FIG. 2, the MFP 100 includes a monochrome laser printer (B&W LP) 101; a color laser printer (Color LP) 102; an HDD 103; a hardware resource 104 such as a scanner, a facsimile, and a memory; a communication I/F (interface) 105; an operation panel 106; and a software group 110 that is constituted by a platform 120 and an application 130.

The platform 120 includes a control service that interprets process requests received from the application 130 and creates obtain requests for hardware resources; a system resource manager (SRM) 123 that manages a hardware resource or a plurality of hardware resources and mediates between the obtain requests from the control service; and a versatile operating system (OS) or general purpose OS 121.

The control service includes a plurality of service modules. Specifically, the control service includes a system control service (SCS) 122, an engine control service (ECS) 124, a memory control service (MCS) 125, an operation panel control service (OCS) 126, a fax control service (FCS) 127, a network control service (NCS) 128, a new remote service (NRS) 129, and an application installation control service 131. The platform 120 includes an application program interface (API) that can receive the process requests from the application 130 in accordance with a function defined in advance.

The versatile operating system 121 is a general purpose operating system such as UNIX (registered trademark) and performs a parallel execution as a process of each piece of the software included in the platform 120 and the application 130.

The SRM 123 controls the system and manages the resources together with the SCS 122. The SRM 123 performs a process for mediating in accordance with a request from a higher layer that uses the hardware resources, such as an engine including a scanning unit or a printer unit, a memory, an HDD file, and a host I/O (Centronics I/F, network I/F, IEEE 1394 I/F, RS232C I/F, etc.) and performs an execution control.

Specifically, the SRM 123 determines whether the requested hardware resource is available (whether the requested hardware resource is not being used due to another request). If the requested hardware resource is available, the SRM 123 informs the higher layer that the requested hardware resource is available. Alternatively, the SRM 123 can schedule the availability of the hardware resources with respect to a request from the higher layer and directly performs the content of the request (e.g., paper conveyance and image forming operation performed by a printer engine, allocation of memory, creation of files, etc.).

The SCS 122 performs processes such as application management, operating unit control, system screen display, LED display, resource management, and interrupt application control.

The ECS 124 performs a process for controlling the engine of the hardware resource 104 including, for example, the monochrome laser printer (B&W LP) 101, the color laser printer (Color LP) 102, a scanner, and a facsimile.

The MCS 125 obtains and releases an image memory; uses the hard disk drive (HDD) 103; compresses and decompresses image data; and the like.

The OCS 126 controls the operation panel 106, which serves as an information transmission unit between an operator (user) and a main body controller. The OCS 126 obtains, from the operation panel 106, a keypress (or a touch operation) as a key event. The OCS 126 includes a portion of an OCS process in which a key event function that corresponds to the obtained key is sent to the SCS 122. The OCS 126 also includes a portion of OCS library are registered in advance in which a drawing function that performs a drawing output, sent to the operation panel 106, of various screens requested by the application 130 or the control service and a function that controls the operation panel 106 or the like. The OCS library is installed by being linked to each module in the application 130 and the control service. It is possible to configure the OCS such that the entire OCS 126 acts as a process, or alternatively, to configure the OCS such that the entire OCS 126 acts as an OCS library.

The FCS 127 provides, from each application layer of the system controller, an API for facsimile transmission and reception using a PSTN/ISDN network; registration/citation of various kinds of facsimile data managed by BKM (backup SRAM); facsimile reading; facsimile reception printing; and merged transmission and reception.

The NCS 128 performs a process for providing commonly available services to applications that require a network I/O. The NCS 128 distributes data, which is received by each protocol from the network 80 side, to each of the applications and mediates when the data is transmitted from the application to the network 80.

The NRS 129 has a scheduler function and a function related to equipment remote management that is performed via the network 80 in which, for example, data is converted when the data is transmitted/received via the network 80.

The application installation control service 131 controls the downloading, to the MFP 100, of various programs delivered from the program delivery server 500 and other application programs and controls installation thereof. Details of the application installation control service 131 will be described later.

The application 130 has a page description language (PDL); a printer application 111 serving as an application for a printer having PCL and PostScript (PS); a copy application 112 serving as an application for a copier; a fax application 113 serving as an application for a facsimile; a scanner application 114 serving as an application for a scanner; a network file application 115 serving as an application for network files; a process checking application 116 serving as an application for checking processes; and a WEB application 117 that acts as a WEB server (http server) with respect to the client terminal such as a PC connected to the Internet and that displays, on a WEB browser running on the client terminal, various screens.

Each process of the application 130 and each process of the control service implement a user service related to an image forming process, such as a copier, a printer, a scanner, and a facsimile, while communication between processes is performed by a function call, a return value transmission, and message transmission/reception.

In this way, multiple applications 130 and multiple control services are provided in the MFP 100 according to the embodiment, both of which act as processes. Inside each process, one or a plurality of threads is created, and then parallel execution is performed for each thread. The control service supplies common services to the application 130. Accordingly, these multiple processes supply a user service related to the image forming process, such as a copier, a printer, a scanner, and a facsimile, while cooperating with each other by performing communication between processes and performing a parallel operation and a parallel operation for threads.

Furthermore, with the MFPs 100 according to the embodiment, customers of the MFP 100 and third parties such as third vendors can install an external application 172 that they have developed on the application layer that is higher than the control service layer. The external application 172 can be downloaded by the application installation control service 131 via the network 80 and installed in the MFP 100.

Furthermore, in the MFP 100 according to the embodiment, multiple processes of the application 130 and multiple processes of the control service are operated; however, the configuration is not limited thereto. For example, it is possible to configure a single process of application 130 and a single process of control service. Furthermore, each application in the application 130 can be added or deleted for each application. Specifically, as described above, the external application 172 can be installed and can be uninstalled.

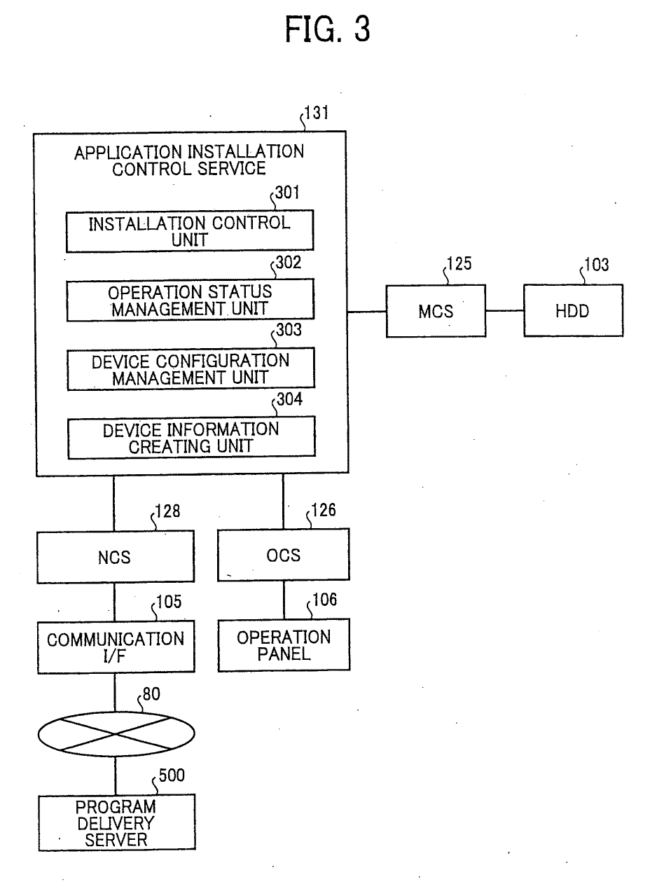

In the following, details of the application installation control service 131 will be described. FIG. 3 is a block diagram illustrating the functional configuration, which is used to execute a typical process implemented by the embodiment, of the application installation control service 131. As illustrated in FIG. 3, the application installation control service 131 includes, as a functional configuration for executing a typical process of the embodiment, an installation control unit 301, an operation status management unit 302, a device configuration management unit 303, and a device information creating unit 304. The application installation control service 131 controls a download, to the MFP 100 via the network 80, of various programs delivered from the program delivery server 500 and controls the installation thereof. This is done by using processes implemented by each functional configuration, while cooperating with the OCS 126 that controls the operation panel 106; the NCS 128 that controls the communication I/F 105; and the MCS 125 that controls the use of the HDD 103.

By cooperating with the OCS 126, the installation control unit 301 observes an operation input performed by a user using the operation panel 106 and determines whether an operation input in which a user requests a download of a program has been performed. Specifically, on the operation panel 106, an operation window (hereinafter, referred to as an “application window”) that corresponds to application function currently in progress is displayed. In the application window, a download button for instructing, by a user, a program to be downloaded is arranged. When the user presses the download button in the application window that is displayed on the operation panel 106, the installation control unit 301 obtains, from the OCS 126, the information thereon and determines that an operation input in which a user requests a download of a program has been performed.

Furthermore, if the installation control unit 301 determines that an operation input in which a user requests a download of a program has been performed, the installation control unit 301 requests, from the device information creating unit 304, the creation of device information. Then, if the device information creating unit 304 creates the device information, the installation control unit 301 obtains the device information and performs, by cooperating with the NCS 128, a control for sending, from the communication I/F 105 to the program delivery server 500 via the network 80, the device information together with a download list send request.

Furthermore, by cooperating with the NCS 128, the installation control unit 301 receives the download list, as a response to a send request for the download list, that is sent from the program delivery server 500; by cooperating with the OCS 126, changes the screen displayed on the operation panel 106 from the application window to the download window; and controls the displaying of the download list on the download window.

Furthermore, by cooperating with the OCS 126, the installation control unit 301 observes the operation input performed by the user using the operation panel 106. When the user performs an operation input that selects, from the download list displayed on the download window, a desired program, the installation control unit 301 creates a download start request in which the program selected by the user is specified as a program to be downloaded. Then, by cooperating with the NCS 128, the installation control unit 301 controls the sending of the download start request from the communication I/F 105 to the program delivery server 500 via the network 80.

Furthermore, by cooperating with the NCS 128, the installation control unit 301 receives (downloads), as a response to the download start request, the program that is sent from the program delivery server 500 and performs an install process of the program in accordance with specified information.

The operation status management unit 302 manages the status of the input operation performed by the user using the operation panel 106. Specifically, by cooperating with the OCS 126, the operation status management unit 302 observes the application window displayed on the operation panel 106 and observes the input operation performed by the user using the operation panel 106. Then, every time the user performs an operation input, by cooperating with the MCS 125, the operation status management unit 302 stores, in the HDD 103, the content of the operation as a user operation input history. Furthermore, if the device information creating unit 304 requests information on the operation status, the operation status management unit 302 specifies the application window that is displayed on the operation panel 106 at that time, i.e., at the time the user requests a download of a program; accesses the HDD 103 to read necessary information; creates information on the operation status of the MFP 100 (including information on the application window that is displayed, when the user requests a download of a program, on the operation panel 106 and including information on an operation history related thereto); and supplies the information to the device information creating unit 304.

The device configuration management unit 303 manages the installation status of peripheral equipment that is installed as an option in the MFP 100 and also manages the current configuration of the MFP 100, i.e., the software configuration such as the type of the application 130 installed in the MFP 100 or the version thereof. Specifically, the HDD 103 stores therein information on the initial configuration of the MFP 100. When new peripheral equipment is installed in the MFP 100, when an application is added to the application 130, or when the version of the application 130 is updated, by cooperating with the MCS 125, the device configuration management unit 303 updates configuration information on the MFP 100 stored in the HDD 103. Furthermore, if the device information creating unit 304 requests the configuration information on the MFP 100, the device configuration management unit 303 accesses the HDD 103 to read the necessary information; creates information indicating the configuration, at that time, of the MFP 100; and supplies the information to the device information creating unit 304.

If the installation control unit 301 requests the creation of device information, the device information creating unit 304 obtains, from the operation status management unit 302, information on the operation status of the MFP 100 related to an application that is operated when a user requests a download of a program and also obtains, from the device configuration management unit 303, the information indicating the configuration of the MFP 100. Then, using these pieces of information, the device information creating unit 304 creates device information, which is necessary for the program delivery server 500 to create a download list according to the operation status of the MFP 100, and supplies the device information to the installation control unit 301.

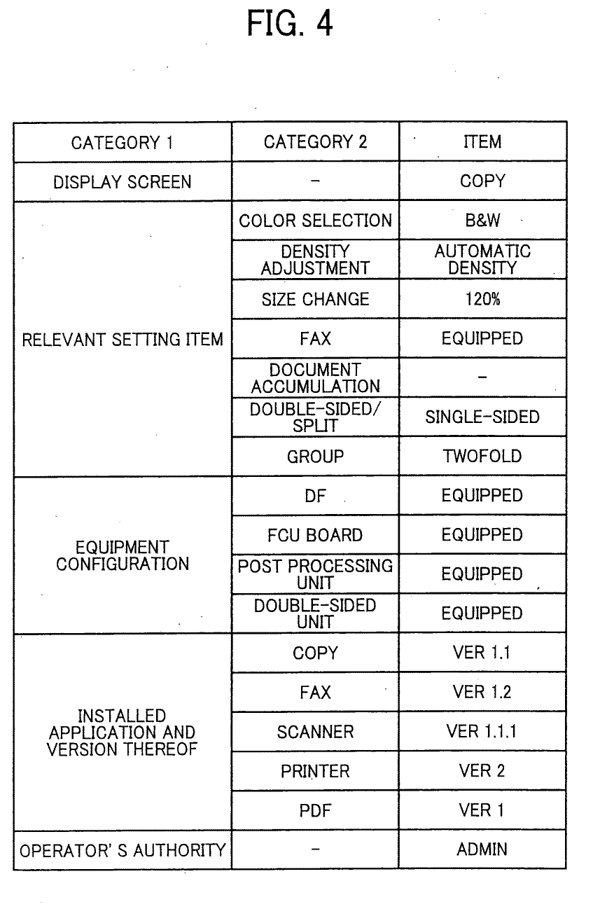

An example of device information created by the device information creating unit 304 is illustrated in FIG. 4. As illustrated in FIG. 4, the device information contains information, such as a “display screen”, a “relevant setting item”, an “equipment configuration”, an “installed application and the version thereof”, and “operator's authority”.

The “display screen” indicates what type of application window is displayed on the operation panel 106 when a user requests a download of a program. The information on the “display screen” is obtained from the operation status management unit 302.

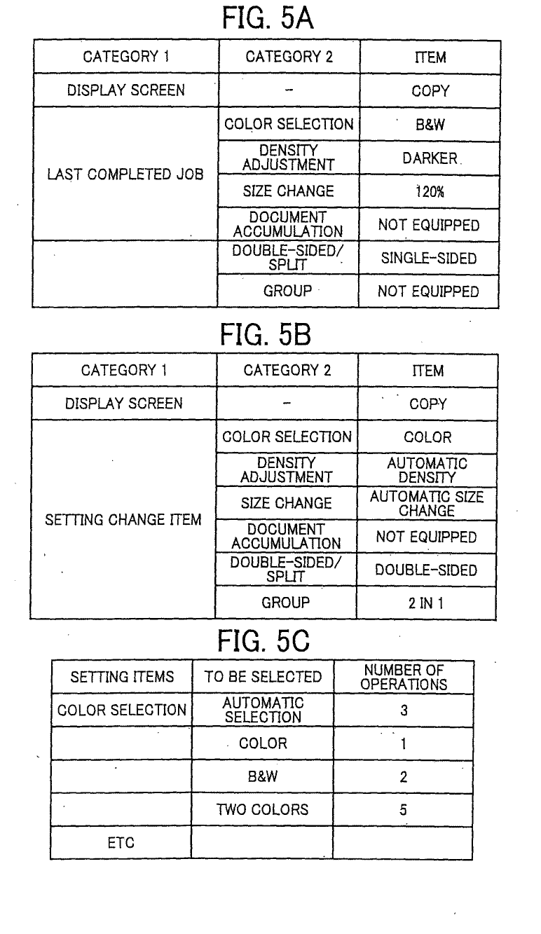

The “relevant setting item” indicates a setting item that is related to an application window that is displayed on the operation panel 106 when a user requests a download of a program. The “relevant setting item” is created from information on a user operation history that is related to the application window. The information on the user operation history is obtained, together with the information on the “display screen”, from the operation status management unit 302. Examples of such information on the user operation history include, for example, as illustrated in FIG. 5A, information on a job that has been completed just before a user requests a download of a program; as illustrated in FIG. 5B, information on a setting value that is changed from an initial value before the user requests a download of the program; and as illustrated in FIG. 5C, information on the number of operations for each setting item that is performed until the user requests a download of the program. Using one or a plurality of pieces of information on the operation histories, the device information creating unit 304 creates the information on the “relevant setting item”.

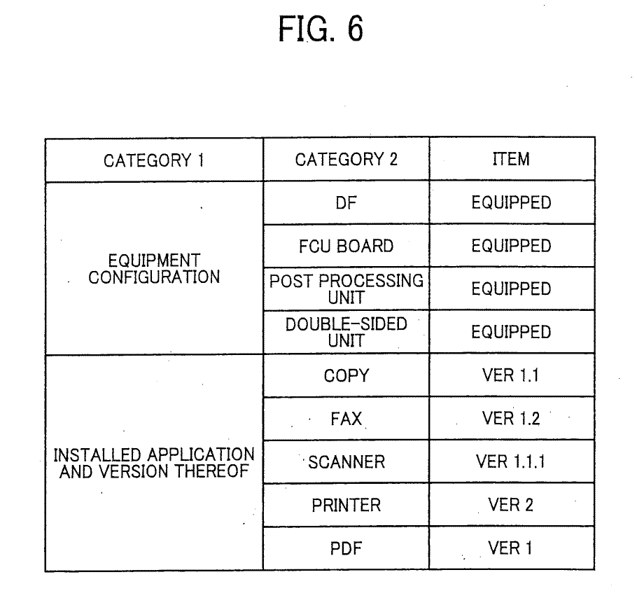

The “equipment configuration” indicates peripheral equipment that is installed in the MFP 100 as an option. The “installed application and the version thereof” indicates applications installed in the MFP 100 and the versions of the applications installed. The information on the “equipment configuration”, the “installed application and the version thereof” are obtained from the device configuration management unit 303 as information indicating, for example, as illustrated in FIG. 6, the configuration of the MFP 100.

The “operator's authority” indicates the location of the authority that is delegated to download a program in the MFP 100. The information on the “operator's authority” is stored in the HDD 103 as, for example, equipment management information. When the device information creating unit 304 creates the device information, by cooperating with the MCS 125, the device information creating unit 304 accesses the HDD 103 to obtain the information on the “operator's authority”.

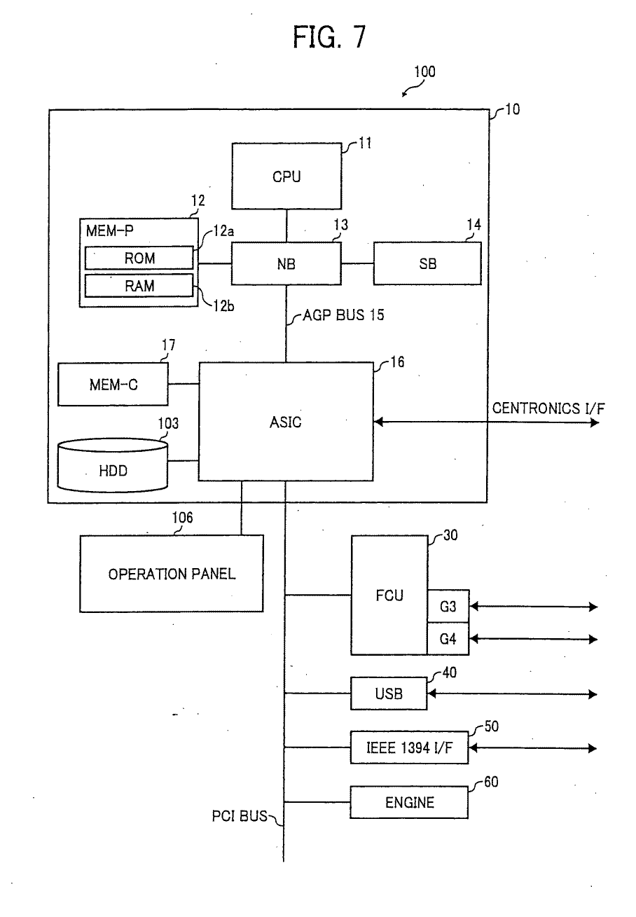

In the following, the hardware configuration of the MFP 100 that is used to implement the above described functional configuration will be described using specific examples. FIG. 7 is a block diagram illustrating the hardware configuration of the MFP 100 according to the embodiment. As illustrated in FIG. 7, the MFP 100 is configured such that a controller 10 is connected to an engine unit (engine) 60 using a peripheral component interface (PCI) bus. The controller 10 performs the overall control of the MFP 100 and also controls the drawing, the communication, and the inputting received from an operating unit (not shown). The engine unit 60 is a printer engine that can be connected to the PCI bus. The engine unit 60 is, for example, a black-and-white plotter, a single-drum color plotter, a four-drum color plotter, a scanner, and a facsimile unit. In addition to the engine unit such as a plotter, the engine unit 60 includes an image processing unit that performs, for example, error diffusion or gamma conversion.

The controller 10 includes a CPU 11, a northbridge (NB) 13, a system memory (MEM-P) 12, a southbridge (SB) 14, a local memory (MEM-C) 17, an application specific integrated circuit (ASIC) 16, and the hard disk drive (HDD) 103. The northbridge (NB) 13 is connected to the ASIC 16 by an accelerated graphics port (AGP) bus 15.

The CPU 11 performs the overall control of the MFP 100; has a chip set that includes the NB 13, the MEM-P 12, and the SB 14; and is connected to other devices via the chip set.

The NB 13 is a bridge that is used to connect the CPU 11, the MEM-P 12, the SB 14, and the AGP 15. The NB 13 includes a memory controller that performs read/write control with respect to the MEM-P 12 and includes a PCI master and an AGP target.

The MEM-P 12 is a system memory that is used as a storage memory in which programs or data are stored, a load memory in which programs or data are loaded, and a drawing memory for the printer. The MEM-P 12 includes a read only memory (ROM) 12a and a random access memory (RAM) 12b. The ROM 12a is a read only memory in which programs or data are stored. The RAM 12b is a writable and readable memory that is used as the load memory on which programs or data are loaded or used as the drawing memory for the printer.

The SB 14 is a bridge that is used to connect the NB 13, a PCI device, and peripheral devices. The SB 14 is connected to the NB 13 via the PCI bus to which, for example, the communication I/F 105 is connected.

The ASIC 16 is an integrated circuit (IC) that includes a hardware component for image processing. The ASIC 16 connects, as a bridge, the AGP 15, the PCI bus, the HDD 103, and the MEM-C 17. The ASIC 16 includes the PCI target and an AGP master; an arbiter (ARB) serving as a main unit of the ASIC 16; a memory controller that controls the MEM-C17; a plurality of direct memory access controllers (DMACs) that rotates image data using a hardware logic or the like; and a PCI unit that transfers data to/from the engine unit 60 via the PCI bus. The ASIC 16 is connected to, via the PCI bus, a facsimile control unit (FCU) 30, an universal serial bus (USB) 40, and the Institute of Electrical and Electronics Engineers 1394 (IEEE 1394) interface 50. The operation panel 106 is directly connected to the ASIC 16.

The MEM-C17 is a local memory that is used as an image buffer for copying and a code buffer. The hard disk drive (HDD) 103 is a storage device that stores therein image data, programs, font data, form data, and various kinds of information.

The AGP 15 is a bus interface for a graphics accelerator card that is designed to speed up graphics processing. By directly accessing the MEM-P12 at high throughput, the graphics accelerator card performs processing at high speed.

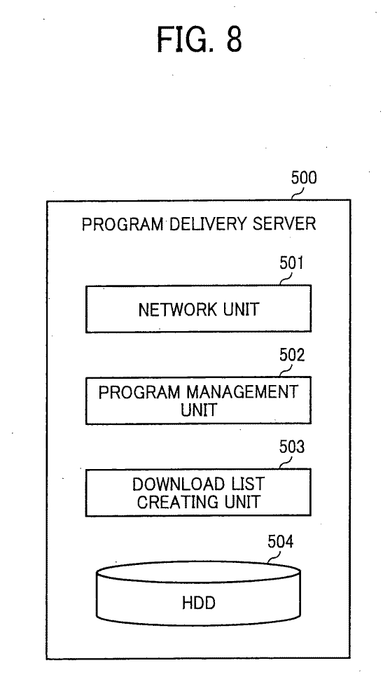

In the following, details of the program delivery server 500 will be described. FIG. 8 is a block diagram illustrating the functional configuration of the program delivery server 500. As illustrated in FIG. 8, the program delivery server 500 includes a network unit 501, a program management unit 502, a download list creating unit 503, and an HDD 504.

All of the programs that can be delivered by the program delivery server 500 are stored in the HDD 504.

The network unit 501 performs information communication with the MFP 100 using the network 80. Specifically, if the MFP 100 sends, via the network 80, device information together with a download list send request, the network unit 501 receives them and supplies, to the download list creating unit 503, the received download list send request and the device information. Furthermore, if the download list creating unit 503 creates a download list according to the operation status of the MFP 100, the network unit 501 obtains the download list and sends, to the MFP 100 via the network 80 as a response to the download list send request from the MFP 100, the download list that is created by the download list creating unit 503.

Furthermore, if the MFP 100 sends, via the network 80, a download start request in which a program to be downloaded is specified, the network unit 501 supplies, to the program management unit 502, the received download start request. If the program management unit 502 supplies a program that is specified by the MFP 100, the network unit 501 sends, to the MFP 100 via the network 80, the program specified by the MFP 100 as a response to the download start request from the MFP 100.

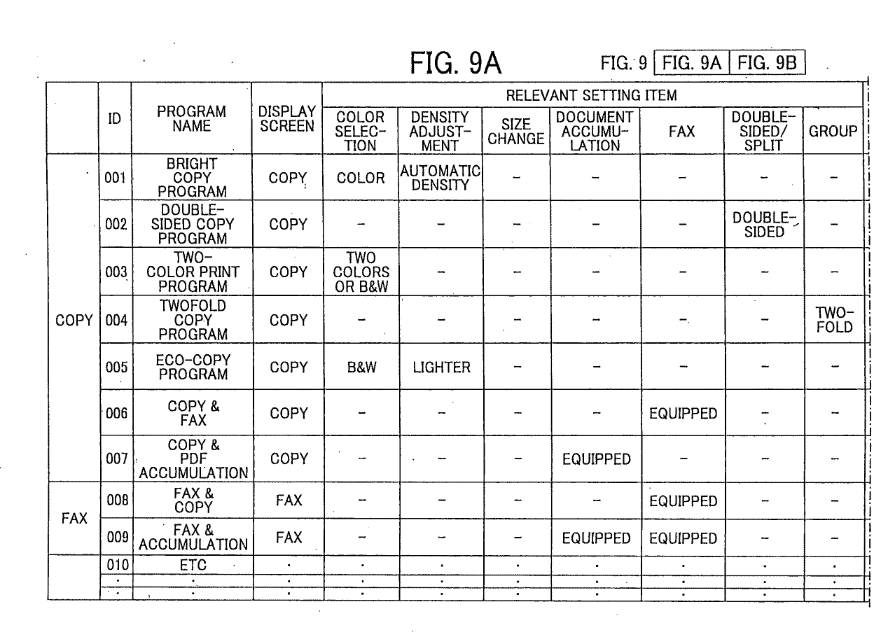

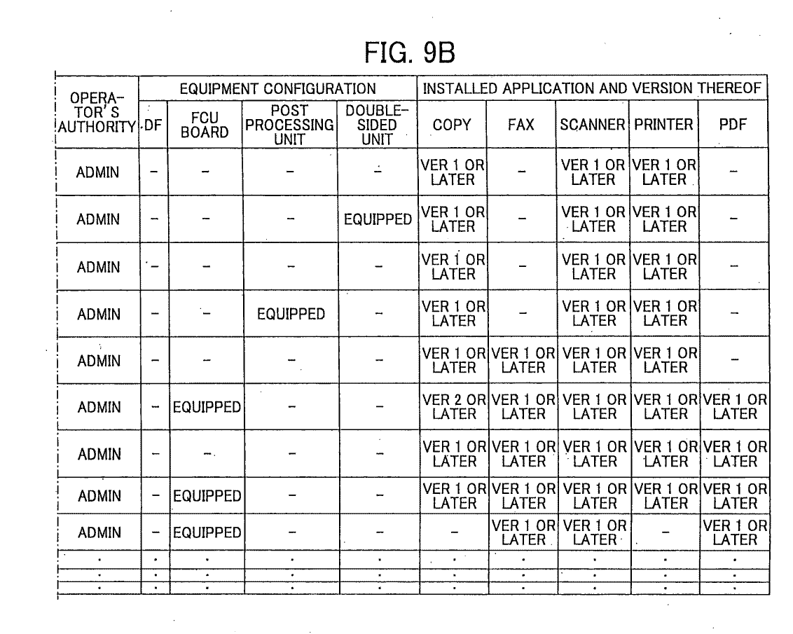

The program management unit 502 manages all of the deliverable programs stored in the HDD 504. Specifically, for all of the programs stored in the HDD 504, the program management unit 502 holds various kinds of information as program management information. Examples of such information include, as illustrated in FIG. 9, a program ID; a program name; a display screen and a relevant setting item, both of which are displayed/used when the program is executed; the operator's authority to download a program; the equipment configuration that is necessary to execute the program; and an application that is necessary to execute the program and the version thereof. The program management information is supplied to the download list creating unit 503 in accordance with a request from the download list creating unit 503.

Furthermore, if the network unit 501 supplies the download start request, the program management unit 502 reads, from the HDD 504, the program that is specified by the download start request and supplies the program to the network unit 501.

If the network unit 501 supplies the download list send request and the device information, using the program management information that is held by the program management unit 502 and using the device information that is sent from the MFP 100 via the network 80, the download list creating unit 503 creates a download list by extracting, from among all of the deliverable programs stored in the HDD 504, only programs that correspond to the operation status of the MFP 100 and then supplies the created download list to the network unit 501.

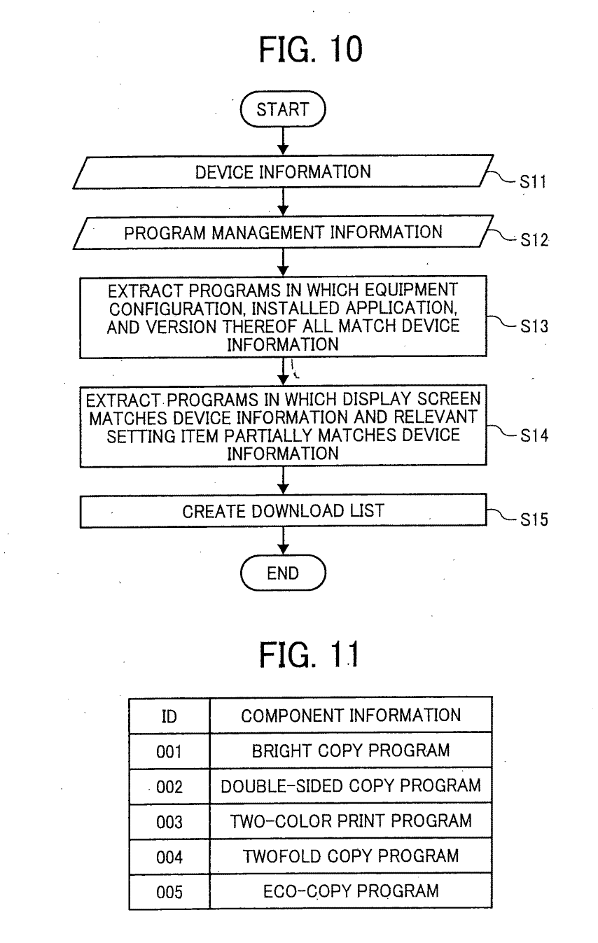

FIG. 10 is a flowchart illustrating an example flow of a download list creating process performed by the download list creating unit 503. When the download list creating unit 503 obtains, from the network unit 501, a download list send request and the device information (Step S11), the download list creating unit 503 requests, from the program management unit 502, program management information and obtains, from the program management unit 502, program management information (Step S12).

Then, the download list creating unit 503 checks device information obtained at Step S11 against program management information obtained at Step S12 and extracts, from among all of the deliverable programs stored in the HDD 504, programs in which the equipment configuration, the installed application, and the version thereof all match the device information (Step S13).

Then, from among the programs extracted at Step S13, the download list creating unit 503 extracts programs in which a display screen matches the device information and the relevant setting item partially matches the device information (Step S14). Then, the download list creating unit 503 creates a download list in which the programs extracted at Step S14 are listed (Step S15).

Specifically, for example, if the MFP 100 sends the device information that is illustrated in FIG. 4 and if the program management unit 502 holds the program management information that is illustrated in FIG. 9, the download list creating unit 503 checks the device information against the program management information. The download list creating unit 503 extracts a “bright copy program”, a “double-sided copy program”, a “two-color print program”, a “twofold copy program”, an “eco-copy program”, a “copy & FAX”, a “copy & PDF accumulation”, a “FAX & copy”, and a “FAX & accumulation” as programs that all match the equipment configuration, the installed application, and the version thereof. Then, because the display screen is a “copy”, the download list creating unit 503 extracts, from the programs, the “bright copy program”, the “double-sided copy program”, the “two-color print program”, the “twofold copy program”, the “eco-copy program”, the “copy & FAX”, and the “copy & PDF accumulation”. The download list creating unit 503 further extracts, from among the above, the “bright copy program”, the “double-sided copy program”, the “two-color print program”, the “twofold copy program”, and the “eco-copy program”, which partially match the relevant setting item. As a result, a download list like that illustrated in FIG. 11 is created.

The download list created by the download list creating unit 503 is supplied to the network unit 501 and is sent, to the MFP 100 that sends a download list creation request via the network 80, as a response to the download list creation request.

The program delivery server 500 that implements the functional configuration described above is configured as hardware using a commonly used computer that includes, for example, a control unit such as a CPU; a storage unit such as a ROM or a RAM; an HDD or an external storage unit such as a CD drive unit; a display unit such as a display; and an input device such as a keyboard or a mouse.

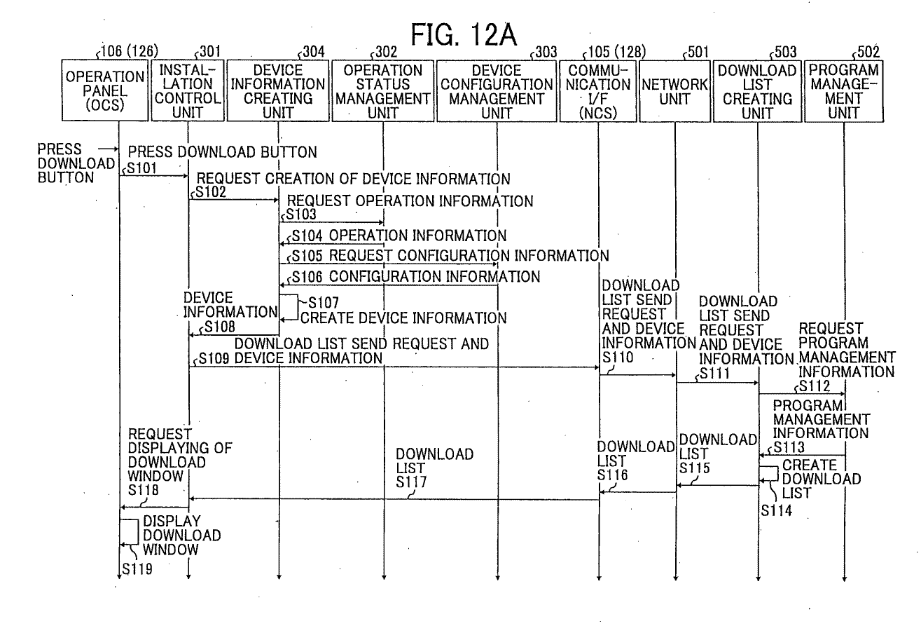

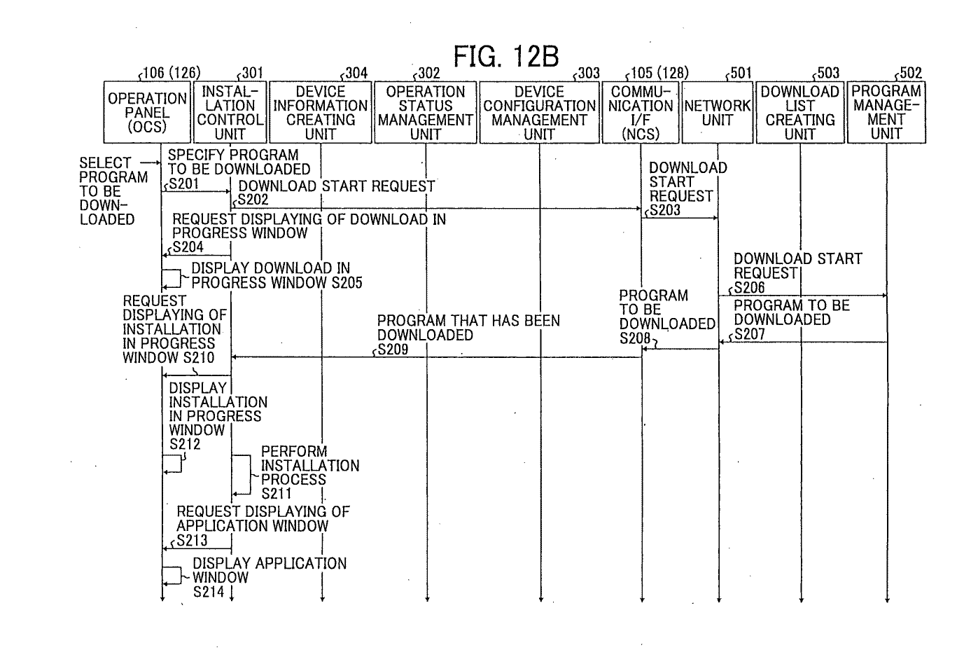

In the following, a program download process that is sequentially performed by the program download system according to the embodiment that is configured in the manner described above will be described with reference to FIGS. 12A and 12B. FIG. 12A is a sequence diagram illustrating the flow of a process performed from when a user performs an operation input that requests a download of a program using the operation panel 106 in the MFP 100 until when a download list is displayed on the operation panel 106 download list. FIG. 12B is a sequence diagram illustrating the flow of a process performed from when a user performs an operation input that selects, from the download list displayed on the operation panel 106, a desired program until when the program is installed in the MFP 100.

As illustrated in FIG. 12A, when a user presses the download button in the application window that is displayed on the operation panel 106 in the MFP 100, information indicating that the download button has been pressed by the user is supplied from the OCS 126 to the installation control unit 301 in the application installation control service 131 (Step S101).

In response to the information from the OCS 126, the installation control unit 301 in the application installation control service 131 determines that an operation input in which a user requests a download of a program has been performed and then requests, from the device information creating unit 304, the creation of the device information (Step S102).

If the installation control unit 301 requests the creation of the device information, the device information creating unit 304 requests, from the operation status management unit 302, information related to the operation status of the MFP 100 (Step S103) and obtains, from the operation status management unit 302, information on the application window that is displayed on the operation panel 106 when a user requests a download of a program and operation information that includes information on the related operation history (Step S104). Furthermore, the device information creating unit 304 requests, from the device configuration management unit 303, information on the configuration of the MFP 100 (Step S105) and obtains, from the device configuration management unit 303, information on the configuration of the MFP 100 indicating, for example, the installation status of the peripheral equipment of the MFP 100 or the software configuration when a user requests a download of a program (Step S106). Then, using the information obtained from the operation status management unit 302 and the information obtained from the device configuration management unit 303, the device information creating unit 304 creates device information that is necessary to create, in the program delivery server 500, a download list according to the operation status of the MFP 100 (Step S107) and supplies the created device information to the installation control unit 301 (Step S108).

If the installation control unit 301 obtains, from the device information creating unit 304, the device information, the installation control unit 301 supplies, to the NCS 128, the device information together with the download list send request (Step S109). If the NCS 128 obtains, from the installation control unit 301, the download list send request and the device information, the NCS 128 controls the communication I/F 105 and then sends, to the program delivery server 500 via the network 80, the download list send request and the device information (Step S110).

The download list send request and the device information that are sent from the MFP 100 to the program delivery server 500 via the network 80 is received by the network unit 501 in the program delivery server 500. If the network unit 501 in the program delivery server 500 receives the download list send request and the device information that are sent from the MFP 100, the network unit 501 supplies the download list send request and the device information to the download list creating unit 503 (Step S111).

If the download list creating unit 503 obtains the download list send request and the device information, the download list creating unit 503 requests, from the program management unit 502, program management information (Step S112) and obtains, from the program management unit 502, the program management information on all of the deliverable programs stored in the HDD 504 (Step S113). Then, the download list creating unit 503 checks the device information that is sent from the MFP 100 via the network 80 against the program management information that is obtained from the program management unit 502; creates a download list by extracting, from all of the deliverable program stored in the HDD 504, only the programs that correspond to the operation status of the MFP 100 (Step S114); and supplies the created download list to the network unit 501 (Step S115).

If the network unit 501 obtains the download list from the download list creating unit 503, the network unit 501 sends the download list, as a response to the download list send request, to the MFP 100 via the network 80 (Step S116).

The download list that is sent from the program delivery server 500 to the MFP 100 via the network 80 is received by the communication I/F 105 in the MFP 100 and is supplied, by the NCS 128, to the installation control unit 301 in the application installation control service 131 (Step S117). If the installation control unit 301 in the application installation control service 131 obtains the download list that is sent from the program delivery server 500 via the network 80, the installation control unit 301 requests, from the OCS 126, the displaying of the download list on the download window on the operation panel 106 (Step S118).

In response to the display request from the installation control unit 301, the OCS 126 controls the screen drawing of the operation panel 106; changes the display screen on the operation panel 106 from the application window to download window; and displays the download list on the download window (Step S119).

Then, as illustrated in FIG. 12B, using the download window displayed on the operation panel 106 in the MFP 100, if a user performs an operation input that selects a program in the download list, information indicating that a program to be downloaded has been selected is supplied from the OCS 126 to the installation control unit 301 in the application installation control service 131 (Step S201).

In response to the information from the OCS 126, the installation control unit 301 in the application installation control service 131 creates a download start request that specifies the program to be downloaded and supplies the created download start request to the NCS 128 (Step S202). If the NCS 128 obtains, from the installation control unit 301, the download start request that specifies the program to be downloaded, the NCS 128 controls the communication I/F 105 and sends the download start request to the program delivery server 500 via the network 80 (Step S203).

Furthermore, after the installation control unit 301 in the application installation control service 131 supplies the download start request to the NCS 128, the installation control unit 301 request, from the OCS 126, the displaying of a download in progress window on the operation panel 106 (Step S204).

In response to the display request from the installation control unit 301, the OCS 126 controls the screen drawing of the operation panel 106 and then changes the download window displayed on the operation panel 106 to the download in progress window (Step S205).

The download start request that is sent from the MFP 100 to the program delivery server 500 via the network 80 is received by the network unit 501 in the program delivery server 500. If the network unit 501 in the program delivery server 500 receives the download start request from the MFP 100, the network unit 501 supplies the received download start request to the program management unit 502 (Step S206).

If the program management unit 502 receives the download start request, the program management unit 502 searches the HDD 504 using the program management information; reads, from the HDD 504, the program that is specified by the download start request; and supplies the program to the network unit 501 (Step S207).

If the network unit 501 obtains, from the program management unit 502, the program that is specified by the download start request, the network unit 501 sends, to the MFP 100 via the network 80, the program as a response to the download start request (Step S208).

The program that is sent from the program delivery server 500 to the MFP 100 via the network 80 is received (downloaded) by the communication I/F 105 in the MFP 100, is controlled by the NCS 128, and is supplied to the installation control unit 301 in the application installation control service 131 (Step S209). If the download of the program that is sent from the program delivery server 500 has been completed, the installation control unit 301 in the application installation control service 131 requests, from the OCS 126, the displaying of installation in progress window on the operation panel 106 (Step S210) and performs a process for installing the downloaded program (Step S211).

In response to the display request from the installation control unit 301, the OCS 126 controls the screen drawing of the operation panel 106 and changes the download in progress window displayed on the operation panel 106 to the installation in progress window (Step S212).

Furthermore, if the downloaded program has been installed, the installation control unit 301 requests, from the OCS 126, restoring of the display screen on the operation panel 106 to the application window (Step S213).

In response to the display request from the installation control unit 301, the OCS 126 controls the screen drawing on the operation panel 106 and changes the installation in progress window displayed on the operation panel 106 to the application window (Step S214). An operation button for the newly installed program is added to the application window that is displayed on the operation panel 106.

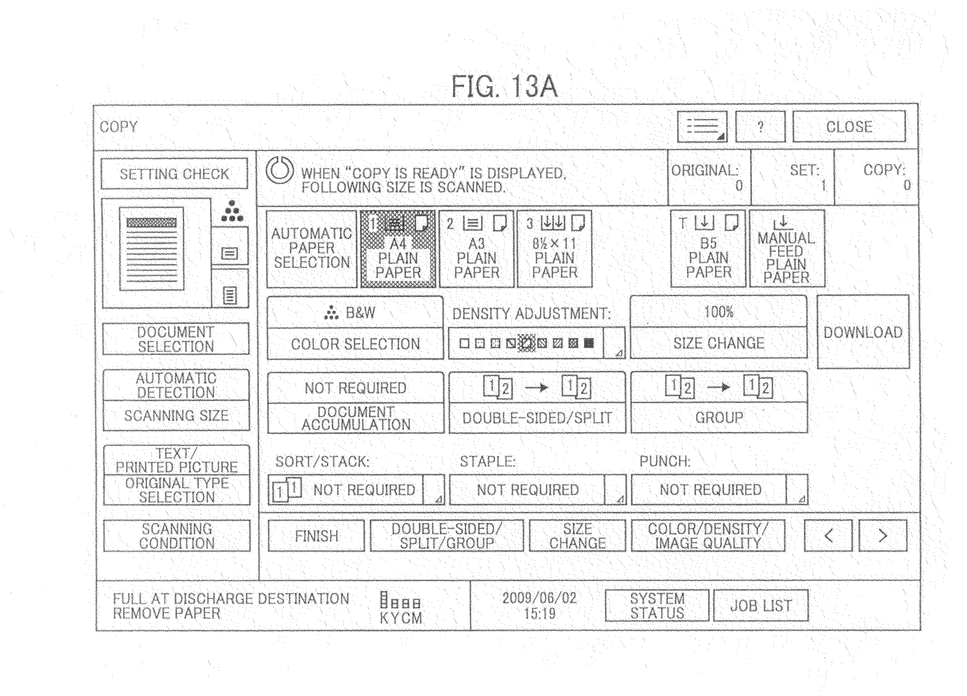

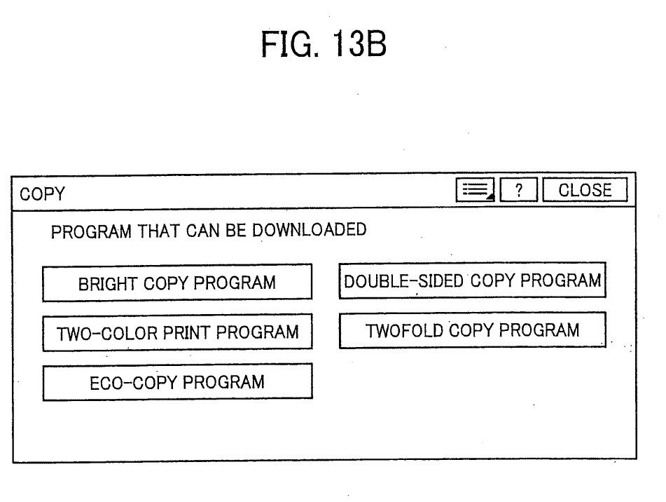

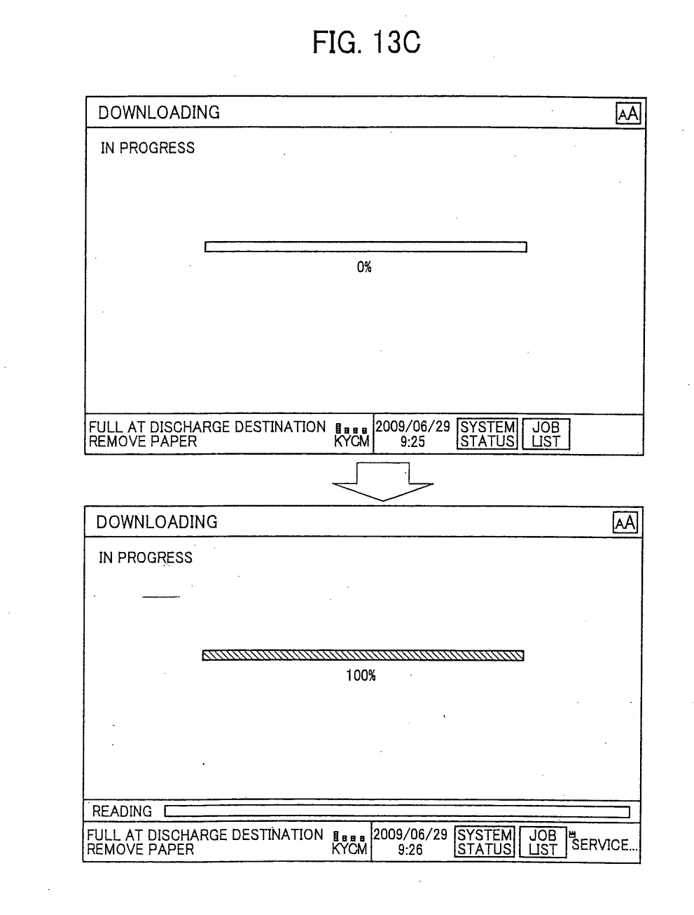

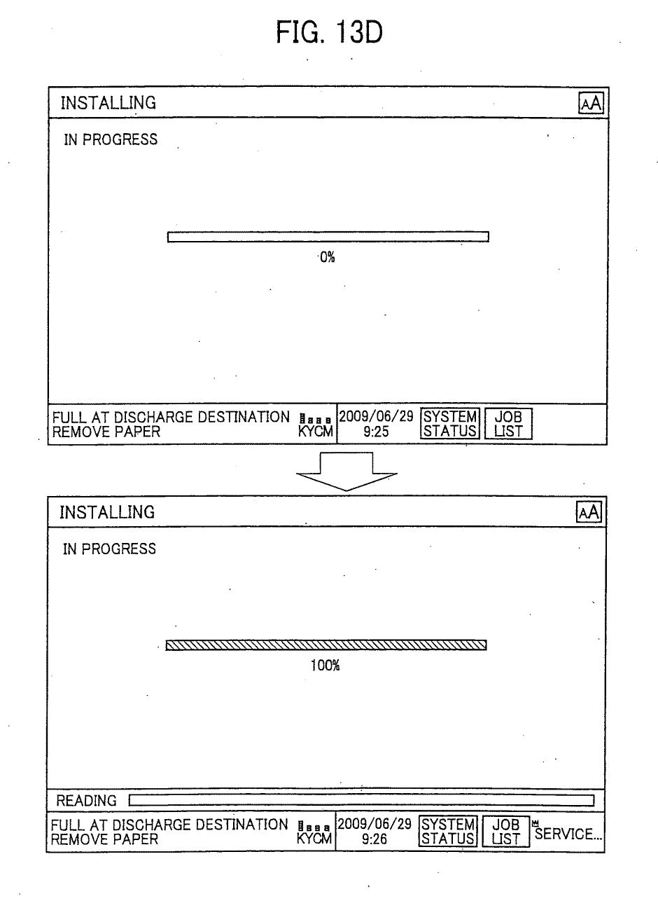

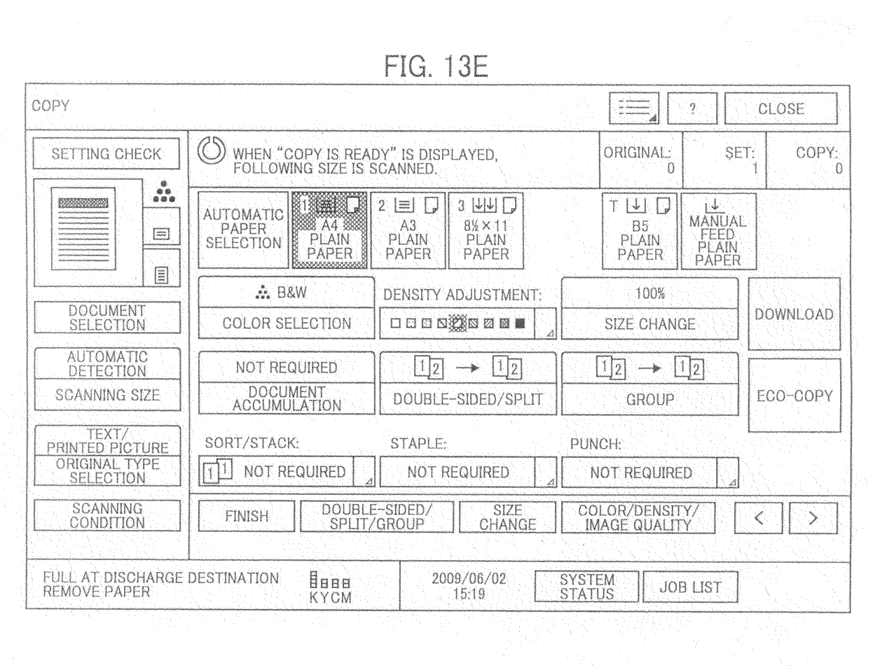

In the following, specific examples of a window change of a window that is displayed on the operation panel 106 and that is sequentially performed in the process described above will be described with reference to FIGS. 13A to 13E.

When the MFP 100 executes an application function selected by a user, as illustrated in FIG. 13A, an application window that is an operation window corresponding to the application in progress is displayed on the operation panel 106. On the application window, a download button is arranged, which is pressed by a user when the user requests a download of a program. FIG. 13A illustrates the application window that is displayed on the operation panel 106 when the copy application 112 is in progress; however, a download button similar to that illustrated in FIG. 13A is also arranged on an application window that corresponds to another application function.

If a user presses the download button arranged on the application window, in accordance with the device information created in the MFP 100, the program delivery server 500 creates a download list. Then, the display screen on the operation panel 106 changes to a download window like that illustrated in FIG. 13B. The download list that is created by the program delivery server 500 is displayed on the download window. On the download window illustrated in FIG. 13B as an example, each program, i.e., the “bright copy program”, the “double-sided copy program”, the “two-color print program”, the “twofold copy program”, and the “eco-copy program”, is displayed in a selectable manner as a candidate program to be downloaded.

Then, if the user performs an operation input that selects, from the download list displayed on the download window, a desired program, the program that is selected by the user is downloaded from the program delivery server 500 to the MFP 100. When the program is downloaded, the download in progress window like that illustrated in FIG. 13C is displayed on the operation panel 106.

Thereafter, when the program has been downloaded and the installation of the program starts, the installation in progress window like that illustrated in FIG. 13D is displayed on the operation panel 106 during the installation of the program.

If the program selected by the user has been installed, the display screen on the operation panel 106 is restored to the application window. If a new program is installed, as illustrated in FIG. 13E, an operation button for the newly installed program is added to the application window that is displayed on the operation panel 106. On the application window illustrated in FIG. 13E as an example, because an “eco-copy program” has been selected by the user and installed, an operation button for executing an eco-copy process is added.

As described in detail using specific examples, with the program download system according to the embodiment, when a user performs, using the operation panel 106 in the MFP 100, an operation input that requests a download of a program, the MFP 100 creates device information including the information on the application window that is displayed on the operation panel 106 at that time; the information on the user operation history related to that application window; the information on the configuration of the MFP 100; and the information on the operator's authority. The MFP 100 then sends the device information to the program delivery server 500. Then, in accordance with the device information sent from the MFP 100, the program delivery server 500 creates a download list by extracting, from among all of the deliverable programs, only the programs that correspond to the operation status of the MFP 100 and sends the download list to the MFP 100. The MFP 100 displays, on the download window of the operation panel 106 in accordance with the device information, the download list of the programs extracted by the program delivery server 500. Accordingly, except for programs that are not related to the application function currently being performed by the MFP 100 and programs that are less likely to be selected by a user as the target download programs, a download list created by appropriately narrowing down the number of programs to be selected is displayed on the download window on the operation panel 106, from which the user can select a desired program from the download list. This makes it possible to reduce the inconvenience of the operation for the user that selects a program to be downloaded.

With the MFP 100 according to the embodiment, if a user requests a download of a program, the MFP 100 creates device information including the information on the application window that is displayed on the operation panel 106 at that time; the information on the user operation history related to the application window; information on the configuration of the MFP 100; and the information on the operator's authority. The MFP 100 then sends the device information to the program delivery server 500. For the device information, if at least information on the application window that is displayed on the operation panel 106 when a user requests a download of a program is included, it is possible to effectively and appropriately narrow down the programs to be listed in the download list. However, if device information that includes information on the user operation history, information on the configuration of the MFP 100, and information on the operator's authority is created, it is possible to further effectively narrow down the programs to be listed in the download list.

For the information on the user operation history that is included in the device information, as described above, it is effective to use information such as information on a job that has been completed just before a user requests a download of a program; information on a setting value that is changed from an initial value before a user requests a download of a program; or information on the number of operations for each setting item that is performed until a user requests a download of a program. By creating the device information using the above mentioned information, it is possible to create the device information that appropriately reflects the operation status of the MFP 100.

With the program download system according to the embodiment, the download button is arranged in the application window on the operation panel 106 in the MFP 100. When a user presses the download button, a process for downloading a program starts. Accordingly, it is possible to start the process for downloading a program without performing a complicated operation, for example, an operation in which the commencement of the download is instructed after an initial setting screen is displayed on the operation panel 106. This makes it possible to reduce the inconvenience of the operation for the user.

In the following, for reference purposes, the correlation between the components described in “What is claimed is” (hereinafter, referred to as “Claims”) and those described in the embodiment will be described as a supplementary note. The “operation window displaying unit” described in the Claims can be implemented by the OCS 126 and the operation panel 106 in the MFP 100 described in the embodiment. The “input unit” described in the Claims can be implemented by the OCS 126 and the operation panel 106 in the MFP 100 described in the embodiment. The “download request determining unit” described in the Claims can be implemented by the installation control unit 301 in the application installation control service 131 in the MFP 100 described in the embodiment. The “device information creating unit” described in the Claims can be implemented by the installation control unit 301 in the application installation control service 131 in the MFP 100 described in the embodiment. The “device information sending unit” described in the Claims can be implemented by the installation control unit 301 in the application installation control service 131, the NCS 128, and the communication I/F 105 in the MFP 100 described in the embodiment. The “download list receiving unit” described in the Claims can be implemented by the installation control unit 301 in the application installation control service 131, the NCS 128, and the communication I/F 105 in the MFP 100 described in the embodiment. The “download list displaying unit” described in the Claims can be implemented by the installation control unit 301 in the application installation control service 131, the OCS 126, and the operation panel 106 in the MFP 100 described in the embodiment. The “download start request sending unit” described in the Claims can be implemented by the installation control unit 301 in the application installation control service 131, the NCS 128, and the communication I/F 105 in the MFP 100 described in the embodiment. The “program receiving unit” described in the Claims can be implemented by the installation control unit 301 in the application installation control service 131, the NCS 128, and the communication I/F 105 in the MFP 100 described in the embodiment. The “device information receiving unit” described in the Claims can be implemented by the network unit 501 in the program delivery server 500 described in the embodiment. The “download list creating unit” described in the Claims can be implemented by the program management unit 502 and the download list creating unit 503 in the program delivery server 500 described in the embodiment. The “download list sending unit” described in the Claims can be implemented by the network unit 501 in the program delivery server 500 described in the embodiment. The “download start request receiving unit” described in the Claims can be implemented by the network unit 501 in the program delivery server 500 described in the embodiment. The “program sending unit” described in the Claims can be implemented by the network unit 501 in the program delivery server 500 described in the embodiment. The “operation history storing unit” described in the Claims can be implemented by the operation status management unit 302 in the application installation control service 131, the MCS 125, and the HDD 103 in the MFP 100 described in the embodiment.

In the embodiment described above, the MFP 100 implements each function related to the present invention by executing, for example, the download program that is provided by being installed, in advance, in a ROM or the like. The download program executed by the MFP 100 has a modular structure including programs that are used to implement, in the MFP 100, each unit described above (the operation window displaying unit, the input unit, the download request determining unit, the device information creating unit, the device information sending unit, the download list receiving unit, the download list displaying unit, the download start request sending unit, the program receiving unit, and the operation history storing unit). When hardware is actually used, the CPU (processor) reads the download program from the ROM and executes it, whereby programs that implement each unit are loaded into the main storage device, and each unit described above is implemented.

The download program that is executed by the MFP 100 according to the embodiment can be configured to be provided by storing the download program in a file, in an installable or executable manner, in a computer readable recording medium, such as a CD-ROM, a flexible disk (FD), a CD-R, a digital versatile disk (DVD), or the like.

Furthermore, the download program that is executed by the MFP 100 according to the embodiment can be configured to be provided by storing the download program in a computer connected to the network such as the Internet and downloading the download program via a network. Alternatively, the download program that is executed by the MFP 100 according to the embodiment can be configured to be provided or distributed via a network such as the Internet.

In the embodiment described above, the program delivery server 500 implements each function related to the present invention by executing, for example, the download program that is provided by storing the download program in a file, in an installable or executable manner, in a computer readable recording medium, such as a CD-ROM, flexible disk (FD), a CD-R, a digital versatile disk (DVD), or the like. The download program that is executed by the program delivery server 500 has a modular structure including programs that are used to implement, in the program delivery server 500, each unit described above (the device information receiving unit, the download list creating unit, the download list sending unit, the download start request receiving unit, and the program sending unit). When hardware is actually used, the CPU (processor) reads the download program from the ROM and executes it, whereby programs that implement each unit are loaded into the main storage device, and each unit described above is implemented.

Furthermore, the download program that is executed by the program delivery server 500 according to the embodiment can be configured to be provided by storing the download program in a computer connected to a network such as the Internet and downloading the download program via the network. Alternatively, the download program that is executed by the program delivery server 500 according to the embodiment can be configured to be provided or distributed via a network such as the Internet.

Furthermore, the download program that is executed by the program delivery server 500 according to the embodiment can be configured to be provided by installing, in advance, the download program in a ROM.

In the embodiment described above, it has been mentioned that, as an example, the image forming apparatus according to the present invention is used in an MFP that has at least two functions from among a copy function, a printer function, a scanner function, and a facsimile function; however, the configuration is not limited thereto. For example, an image forming apparatus such as a copying machine, a printer, a scanner, and a facsimile can also be used.

According to the advantages of the embodiment of the present invention, it is possible to appropriately narrow down the number of programs that is listed in a download list and is displayed, thus reducing the inconvenience of the operation for a user who selects and downloads a program.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A program download system comprising:
a program delivery server that delivers a program via an information communication network; and
an image forming apparatus that is connected to the information communication network and downloads the program that is delivered from the program delivery server,
wherein the image forming apparatus includes:
an operation window displaying unit that displays an operation screen that corresponds to an application function that is currently being performed by the image forming apparatus;
an input unit that receives an operation input performed by a user;
a download request determining unit that determines whether an operation input in which a user requests a program download has been performed;
a device information creating unit that creates device information that includes at least information on the operation screen that is displayed on the operation window displaying unit when the user requests the program download;
a device information sending unit that sends, to the program delivery server, the device information together with the download list send request;
a download list receiving unit that receives, as a response to the download list send request, a download list that is sent from the program delivery server;
a download list displaying unit that displays the download list;
a download start request sending unit that sends, to the program delivery server, a download start request that specifies a program that is selected by the user from the download list; and
a program receiving unit that receives, as a response to the download start request, the program that is sent from the program delivery server, and wherein the program delivery server includes:
a device information receiving unit that receives the device information that is sent, together with the download list send request, from the image forming apparatus;
a download list creating unit that extracts, from among all deliverable programs in accordance with the device information, only programs that correspond to an operation status of the image forming apparatus to create the download list;
a download list sending unit that sends the download list to the image forming apparatus;
a download start request receiving unit that receives the download start request that is sent from the image forming apparatus; and
a program sending unit that sends, to the image forming apparatus, the program that is specified by the download start request.

2. The program download system according to claim 1, wherein
the image forming apparatus further includes an operation history storing unit that stores therein history of an operation input performed by a user, and
the device information creating unit creates device information that includes at least information on an operation screen that is displayed on the operation window displaying unit when the user requests the program download and information on operation history related to the operation screen.

3. The program download system according to claim 2, wherein the information on the operation history included in the device information is information indicating a condition of a job that has been completed just before the user requests the program download.

4. The program download system according to claim 2, wherein the information on the operation history included in the device information is information related to a setting value that is changed from an initial value before the user requests the program download.

5. The program download system according to claim 2, wherein the information on the operation history included in the device information is information indicating the number of operations for each setting item that is performed until the user requests the program download.

6. The program download system according to claim 2, wherein
the device information creating unit creates device information that includes at least information on an operation screen that is displayed on the operation window displaying unit when the user requests the program download, information on operation history related to the operation screen, and information related to the configuration of the image forming apparatus, and
the download list creating unit creates the download list by extracting, from among all deliverable programs in accordance with the device information, only programs that correspond to the operation status of the image forming apparatus and that conform to the configuration of the image forming apparatus.

7. The program download system according to claim 6, wherein
the device information creating unit creates device information that creates at least information on an operation screen that is displayed on the operation window displaying unit when the user requests the program download, information on operation history related to the operation screen, information related to the configuration of the image forming apparatus, and information related to an operator's authority, and
the download list creating unit creates the download list by extracting, from among all deliverable programs in accordance with the device information, only programs that correspond to the operation status of the image forming apparatus, that conforms to the configuration of the image forming apparatus, and that conform to the operator's authority.

8. The program download system according to claim 1, wherein
the input unit has a download instruction button that is operated by the user when the user requests the program, and
the download instruction button is arranged on the operation screen and is displayed on the operation window displaying unit in an operable manner.

9. An image forming apparatus that is connected to an information communication network and has a function of downloading a program that is delivered from a program delivery server via the information communication network, the image forming apparatus comprising:
an operation window displaying unit that displays an operation screen that corresponds to an application function that is currently being performed by the image forming apparatus;
an input unit that receives an operation input performed by a user;
a download request determining unit that determines whether an operation input in which a user requests a program download has been performed;
a device information creating unit that creates device information that includes at least information on the operation screen that is displayed on the operation window displaying unit when the user requests the program download;
a device information sending unit that sends, to the program delivery server, the device information together with the download list send request;
a download list receiving unit that receives, as a response to the download list send request, a download list that is sent from the program delivery server;
a download list displaying unit that displays the download list;
a download start request sending unit that sends, to the program delivery server, a download start request that specifies a program that is selected by the user from the download list; and
a program receiving unit that receives, as a response to the download start request, the program that is sent from the program delivery server.

10. The image forming apparatus according to claim 9, wherein
the image forming apparatus further includes an operation history storing unit that stores therein history of an operation input performed by a user, and
the device information creating unit creates device information that includes at least information on an operation screen that is displayed on the operation window displaying unit when the user requests the program download and information on operation history related to the operation screen.

11. The image forming apparatus according to claim 10, wherein the information on the operation history included in the device information is information indicating a condition of a job that has been completed just before the user requests the program download.

12. The image forming apparatus according to claim 10, wherein the information on the operation history included in the device information is information related to a setting value that is changed from an initial value before the user requests the program download.

13. The image forming apparatus according to claim 10, wherein the information on the operation history included in the device information is information indicating the number of operations for each setting item that is performed until the user requests the program download.

14. The image forming apparatus according to claim 10, wherein the device information creating unit creates device information that includes at least information on an operation screen that is displayed on the operation window displaying unit when the user requests the program download, information on operation history related to the operation screen, and information related to the configuration of the image forming apparatus.

15. The image forming apparatus according to claim 14, wherein the device information creating unit creates device information that creates at least information on an operation screen that is displayed on the operation window displaying unit when the user requests the program download, information on operation history related to the operation screen, information related to the configuration of the image forming apparatus, and information related to an operator's authority.

16. The image forming apparatus according to claim 9, wherein
the input unit has a download instruction button that is operated by the user when the user requests the program, and
the download instruction button is arranged on the operation screen and is displayed on the operation window displaying unit in an operable manner.

17. A program delivery server that delivers, to an image forming apparatus that is connected to an information communication network, a program via the information communication network, the program delivery server comprising:
a device information receiving unit that receives, from the image forming apparatus, device information that includes at least information on an operation screen that is displayed on an operation window displaying unit in the image forming apparatus when a user requests a program download in the image forming apparatus;
a download list creating unit that extracts, from among all deliverable programs in accordance with the device information, only programs that correspond to an operation status of the image forming apparatus to create a download list;
a download list sending unit that sends the download list to the image forming apparatus;
a download start request receiving unit that receives a download start request that specifies a program that is selected from the download list by a user in the image forming apparatus; and
a program sending unit that sends, to the image forming apparatus, the program specified by the download start request.

18. The program delivery server according to claim 17, wherein the download list creating unit creates the download list by extracting, from among all deliverable programs in accordance with the device information, only programs that correspond to the operation status of the image forming apparatus and that conform to the configuration of the image forming apparatus.

19. The program delivery server according to claim 18, wherein the download list creating unit creates the download list by extracting, from among all deliverable programs in accordance with the device information, only programs that correspond to the operation status of the image forming apparatus, that conforms to the configuration of the image forming apparatus, and that conform to the operator's authority.
